(19) United States
(12) Patent Application Publication
(10) Pub. No.: US 2023/0136244 A1
(43) Pub. Date: May 4, 2023

(54) VIRTUAL MACHINE CONNECTION CONTROL DEVICE, VIRTUAL MACHINE CONNECTION CONTROL SYSTEM, VIRTUAL MACHINE CONNECTION CONTROL METHOD, AND PROGRAM

(71) Applicant: Nippon Telegraph and Telephone Corporation, Tokyo (JP)

(72) Inventors: Katsumi FUJITA, Musashino-shi, Tokyo (JP); Masashi KANEKO, Musashino-shi, Tokyo (JP); Yoshito ITO, Musashino-shi, Tokyo (JP)

(21) Appl. No.: 17/801,653

(22) PCT Filed: Feb. 26, 2020
(86) PCT No.: PCT/JP2020/007814

§ 371 Date: Aug. 23, 2022

(51) Int. Cl. G06F 9/455

(52) U.S. Cl. CPC G06F 9/45558; G06F 2009/45591; G06F 2009/45595

(57) ABSTRACT

A virtual machine connection control device includes a data collection unit configured to obtain VNF performance measured for arrangements of virtual machines included in an application to be tested on at least two servers in all possible combinations, a degree of coupling analysis unit configured to calculate degrees of coupling associated with communication delay between the virtual machines based on measurement data of the obtained VNF performance, a degree of contention analysis unit configured to calculate degrees of contention associated with degradation of the VNF performance between the virtual machines based on measurement data of the obtained VNF performance, and a scaling control unit configured to determine an arrangement of the virtual machines that provides the VNF performance higher than a predetermined threshold based on the calculated degrees of coupling and the calculated degrees of contention.

### TECHNICAL FIELD

The present invention relates to a virtual machine connection control device, a virtual machine connection control system, and a virtual machine connection control method and program.

### BACKGROUND ART

With the development of virtualization technology using Network Functions Virtualization (NFV), a system is built and operated for each service. Furthermore, instead of building a system for each service, Service Function Chaining (SFC) is becoming mainstream, which divides service functions into reusable modules and operates those modules on independent virtual machines (VMs or containers) so that they can be used as components when needed, thereby improving operability.

In an NFV application (hereinafter referred to as an “app”) having multiple functions, due to the processing characteristics of each component (VM/container), there are VMs that can be bottlenecks leading to performance degradation such as delays and resources contention by data access or data forwarding. Thus, when VMs/containers are arranged on servers, how to combine them is critical for good performance.

For some vendor apps, however, the functions of each VM/container are unknown (black-boxed) and therefore it is difficult to find out arrangements of VMs that can be bottlenecks beforehand to prevent performance degradation.

Non Patent Literature 1 describes a technique of locating performance bottlenecks of a black-box app. The method described in Non Patent Literature 1 is an out-of-band, non-intrusive, application-independent performance diagnosis method.

Non Patent Literature 2 describes a technique of locating performance bottlenecks by mirroring traffic between Virtual Network Function Components (VNFCs) at virtual ports and measuring data to be analyzed such as throughput and delay. The method described in Non Patent Literature 2 performs scaling based on a result of analyzing data (delay and throughput) collected by packet mirroring to make a performance diagnosis for a black-box app. The method described in Non Patent Literature 2 attempts to locate performance bottlenecks when an incoming load exceeds Virtual Network Function (VNF) capacities on the assumption that the format of packets flowing through the VNFs is known.

Non Patent Literature 3 describes a method of locating arrangements of VMs that can be bottlenecks by resolving a combination optimization problem for arrangement.

### CITATION LIST

### Patent Literature

### Non-Patent Literature

Non-Patent Literature 1: Ben-Yehuda et al. (2009) “NAP: a Building Block for Remediating Performance Bottlenecks via Black Box Network Analysis,” ICAC′09, Jun. 15-19, 2009, Barcelona, Spain. Copyright 2009 ACM 978-1-60558-564-2/09/06
Non-Patent Literature 2: Naik et al. (2016) “NFVPerf: Online Performance Monitoring and Bottleneck Detection for NFV”, 978-1-5090-0933-6/16/$31.00 c 2016 IEEE
Non-Patent Literature 3: Fukunaga et al. (2015) “Virtual Machine Placement for Minimizing Connection Cost in Data Center Networks”, 978-1-4673-7131-5/15/$31.00 c 2015 IEEE

### SUMMARY OF THE INVENTION

### Technical Problem

The techniques described in Non Patent Literature 1 to 3 still have the following problems.

(1) The technique described in Non Patent Literature 1 requires VMs for monitoring and analyzing traffic on servers. This can cause resource contention. (2) Delays may occur as a result of packet concentration. In particular, because the VMs for monitoring and analyzing traffic collect packets at the exits and entries of a network, packets concentrate on the exits and entries, which means that this system itself can be a bottleneck.

(1) The technique described in Non Patent Literature 2 does not take into consideration performance degradation due to CPU pinning across Non-Uniform Memory Access (NUMA) nodes. In addition, this system is an online analysis system and does not cover CPU pinning at the time of deployment. (2) Increase of processing caused by port mirroring can have a negative effect on performance.

The technique described in Non Patent Literature 3 is highly abstract because it represents a system using mathematical model. For this reason, there is a big gap between the technique described in Non Patent Literature 3 and actual systems and therefore it is difficult to apply the technique to actual systems.

The present invention has been made in view of the above background. The object of the present invention is to provide a method of determining an arrangement of virtual machines that maximizes VNF performance without real-time data collection, which can easily be applied to an actual system.

### Means for Solving the Problem

To solve the problem described above, the present invention provides a virtual machine connection control device for arranging virtual machines on servers, comprising: a data collection unit configured to obtain VNF performance measured for arrangements of virtual machines included in an application to be tested on at least two servers in all possible combinations; a degree of coupling analysis unit configured to calculate degrees of coupling associated with communication delay between the virtual machines included in the application based on measurement data of the obtained VNF performance; a degree of contention analysis unit configured to calculate degrees of contention associated with degradation of the VNF performance between the virtual machines included in the application based on measurement data of the obtained VNF performance; and a scaling control unit configured to determine an arrangement of the virtual machines that provides the VNF performance higher than a predetermined threshold based on the calculated degrees of coupling and the calculated degrees of contention.

### Effects of the Invention

The present invention can easily be applied to an actual system and make it possible to determine an arrangement of virtual machines which maximizes the VNF performance without real-time data collection.

### BRIEF DESCRIPTION OF DRAWINGS

FIG. 1 is a schematic block diagram of a virtual machine connection control system according to an embodiment of the present invention.

FIG. 2 is a diagram illustrating possible variations when VMs are arranged on two servers by the virtual machine connection control device according to the embodiment of the present invention.

FIG. 3 is a diagram illustrating a test, deployment and scaling by the virtual machine connection control system in a case of arranging VMs on two servers as in FIG. 2.

FIG. 4 is a diagram illustrating a configuration of servers in the form of a graph in the virtual machine connection control device according to the embodiment of the present invention.

FIG. 5 is a diagram illustrating how a configuration of servers can be divided when VMs are arranged on two servers: a server 1 and a server 2 by the virtual machine connection control device according to the embodiment of the present invention.

FIG. 6 is a diagram illustrating a correspondence between degrees of coupling and a measurement result obtained in a test stage in a test environment by the virtual machine connection control device according to the embodiment of the present invention.

FIG. 7 is a diagram illustrating a correspondence between Lijs at which the configuration of the servers can be divided and delays by the virtual machine connection control device according to the embodiment of the present invention.

FIG. 8 is a diagram illustrating a method of finding out characteristics of a distribution for each Lij based on the plot of the Lij and delays shown in FIG. 7.

FIG. 9 is a diagram illustrating a table including Lijs in descending order of their average delay in the virtual machine connection control device according to the embodiment of the present invention.

FIG. 10 is a diagram illustrating comparison between different patterns when the VMs are arranged on the server 1 and the server 2 by the virtual machine connection control device according to the embodiment of the present invention.

FIG. 11 is a diagram for illustrating the degrees of contention of VMs in the virtual machine connection control device according to the embodiment of the present invention.

FIG. 12 is a diagram illustrating the maximum throughput and the VM arranged on the server 2 when the maximum throughput is achieved using the arrangements No. 1 to No. 5 shown in FIG. 11.

FIG. 13 is a diagram illustrating how to determine the optimal server when a VM “4” is added to an arrangement in which five VMs are provided on two servers: a server 1 and a server 2 in the virtual machine connection control device according to the embodiment of the present invention.

FIG. 14 is a diagram illustrating a method of determining a server to which a VM is added when the VM is added to the arrangement shown in FIG. 13.

FIG. 15 is a flow chart for calculating a degree of coupling and a degree of contention in a case where a VM is arranged on each of server m0 and server m1 by the virtual machine connection control device according to the embodiment of the present invention.

FIG. 16 is a diagram illustrating an arrangement of VMs on servers when the flow in FIG. 15 is used.

FIG. 17 is a diagram illustrating a method of determining a server to which a VM is added when the VM is added to the arrangement shown in FIG. 16.

FIG. 18 is a diagram illustrating a configuration of servers in the form of a graph in the virtual machine connection control device according to the embodiment of the present invention.

FIG. 19 is a diagram illustrating how to determine the optimal server when a VM “3” is added to the initial deployment configuration in which five VMs are provided on two servers: a server m0 and a server m1 in the virtual machine connection control device according to the embodiment of the present invention.

FIG. 20 is a diagram illustrating a method of determining a server to which a VM is added when the VM is added to the arrangement shown in FIG. 19.

FIG. 21 is a hardware block diagram illustrating an example of a computer implementing the virtual machine connection control device according to Embodiments of the present invention.

### DESCRIPTION OF EMBODIMENTS

With reference to the drawings, a virtual machine connection control system according to a mode for carrying out the present invention (hereinafter referred to as “the present embodiment”) will be described below.

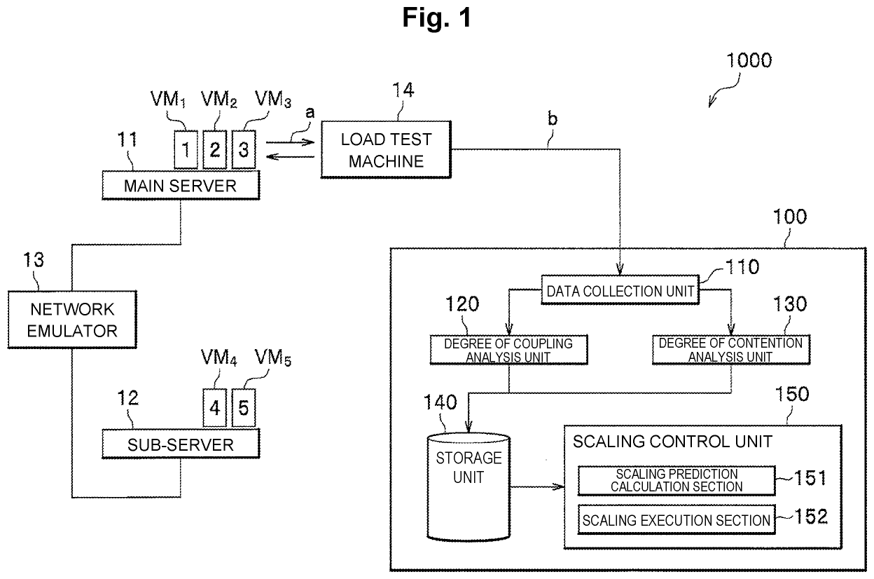

FIG. 1 is a schematic block diagram of the virtual machine connection control system according to the embodiment of the present invention.

As shown in FIG. 1, the virtual machine connection control system 1000 has a configuration in which a network emulator 13 is placed between a main server 11 (Server<1>) on which VMs are provided and a sub-server 12 (Server<2>) for failover.

In the drawings, the main server 11 and the sub-server 12 are represented by horizontally extending blocks and VMs provided on the main server 11 and sub-server 12 are represented by virtually extending rectangular blocks having numbers therein above the horizontally extending blocks. In FIG. 1, three VMs, i.e., VM₁ indicated by “1,” VM₂ indicated by “2” and VM₃ indicated by “3” are provided on the main server 11. Two VMs, i.e., VM₄ indicated by “4” and VM₅ indicated by “5” are provided on the sub-server 12. The same notation is used in the other figures.

A load test machine 14 (load test device), which is an external load device, is connected to the main server 11. The load test machine 14 performs load tests by transmitting and receiving data to and from the main server 11 (see the reference sign “a” in FIG. 1).

The network emulator 13 creates delays to simulate influences on performance by arrangements on different scales such as an arrangement on nearby servers and an arrangement on distant servers.

The load test machine 14 obtains data on delay and the maximum throughput by load tests using the network emulator 13.

The load test machine 14 measures VNF performance by arranging virtual machines included in an application to be tested on at least two servers in all possible combinations.

The load test data obtained by the load test machine 14 is input to a virtual machine connection control device 100 (see the reference sign b in FIG. 1).

[Virtual Machine Connection Control Device 100]

The virtual machine connection control device 100 defines <a degree of coupling between VMs/containers (in the following description, “/” means and/or)> and <a degree of contention of a VM/container> as VNF performance evaluation indexes. The virtual machine connection control device 100 calculates the degree of coupling and the degree of contention for every VM/container included in a black-box app by statistical analysis of data obtained by testing the app and determines an arrangement of the VMs/containers based on the degree of coupling and the degree of contention.

<Degree of Coupling Between VMs/Containers>

Different VMs included in an app communicate with each other at different frequencies. Thus, arrangements of the VMs in some combinations influence communication delay. The degree of coupling between VMs/containers is defined as “a degree of VNF performance degradation due to communication delay between the pair of VMs/containers.” That is, the degree of coupling is defined as “how much VNF performance degradation is caused by communication delay between a pair of VMs/containers.” On the basis of statistical values (the average, median, mode, etc.) of VNF performance values for “a group of arrangements in which a certain pair of VMs/containers are not arranged on the same server” among all the candidate arrangements, the more the VNF performance decreases, the higher the degree of coupling becomes.

<Degree of Contention of VM/Container>

The degree of contention of a VM/container is defined as “a degree of VNF performance degradation caused by contention between the VM/container and another VM/container arranged on the same server.” That is, contention occurs when VMs are provided on the same server depending on the processing characteristics (for example, high memory occupancy rates) of the VMs. The degree of contention is defined herein as “how much VNF performance degradation is caused by contention between a VM/container and other VMs/containers arranged on the same server.”

On the basis of VNF performance values (the VNF performance includes delay and throughput) of an arrangement in which only one virtual machine or container is arranged on one of at least two servers, the more VNF performance decreases, the higher the degree of contention becomes.

The virtual machine connection control device 100 includes a data collection unit 110, a degree of coupling analysis unit 120, a degree of contention analysis unit 130, a storage unit 140 and a scaling control unit 150. The scaling control unit 150 includes a scaling prediction calculation section 151 and a scaling execution section 152.

The data collection unit 110 obtains VNF performance measured for arrangements of virtual machines included in an application to be tested on at least two servers in all possible combinations.

The degree of coupling analysis unit 120 calculates degrees of coupling for VMs/containers included in a black-box app based on measurement data of the VNF performance obtained by the data collection unit 110.

The degree of coupling analysis unit 120 defines the degree of coupling based on how much the VNF performance is degraded by communication delay between a pair of virtual machines or containers and sets the degree of coupling to a larger value as the communication delay degrades the VNF performance more.

The degree of contention analysis unit 130 calculates degrees of contention for VMs/containers included in a black-box app based on measurement data of the VNF performance obtained by the data collection unit 110.

The degree of contention analysis unit 130 defines the degree of contention based on how much the VNF performance is degraded by contention between a virtual machine or container and other virtual machines or containers arranged on the same server, and sets the degree of contention to a larger value as the contention degrades the VNF performance more based on VNF performance values of an arrangement in which only one virtual machine or container is arranged on one of at least two servers.

The storage unit 140 stores measurement data of the VNF performance obtained by the data collection unit 110. The storage unit 140 stores data obtained by a test. The storage unit 140 stores VMs arranged by the scaling control unit 150 based on a measurement result obtained in the test stage.

The scaling control unit 150 determines an arrangement of virtual machines that provides the VNF performance higher than a predetermined threshold (e.g., the maximum VNF performance) based on calculated degrees of coupling and calculated degrees of contention.

In particular, when a virtual machine or container is added, the scaling control unit 150 selects at least two servers from a group of servers that have capacities for the addition of the virtual machine or container and then selects one of the at least two servers based on the calculated degrees of coupling and the calculated degrees of contention.

The scaling control unit 150 determines a server for which the calculated degree of coupling is larger than a first predetermined value and the calculated degree of contention is smaller than a second predetermined value. If a server for which the degree of coupling is larger than the first predetermined value is different from a server for which the degree of contention is smaller than the second predetermined value, the scaling control unit 150 determines which server is less affected in terms of contention and a resource usage rate when the virtual machine is arranged on the server according to predefined service requirements or due to scale out.

When the virtual machine is arranged due to scale out, the scaling prediction calculation section 151 calculates a prediction of scaling of the virtual machine that provides the maximum VNF performance based on the calculated degrees of coupling and the calculated degrees of contention.

The scaling execution section 152 executes scaling for arranging the virtual machine on the server of an actual system based on the optimal arrangement calculated by the scaling prediction calculation section 151.

The operation of the virtual machine connection control device 100 configured in particular is described below.

The operation includes “delay and maximum throughput measurement,” “measurement data analysis,” “deployment,” “suggestion of a candidate optimal arrangement at the time of scale out” and “an operation phase.” These are described below in sequence.

[Delay and Maximum Throughput Measurement]

In the delay and maximum throughput measurement, VNF performance is measured by a load test for all possible arrangements when an app to be tested is executed on two servers. In FIG. 1, delay and the maximum throughput are measured for all possible variations when VMs included in the app are arranged on the two servers (the main server and the sub-server).

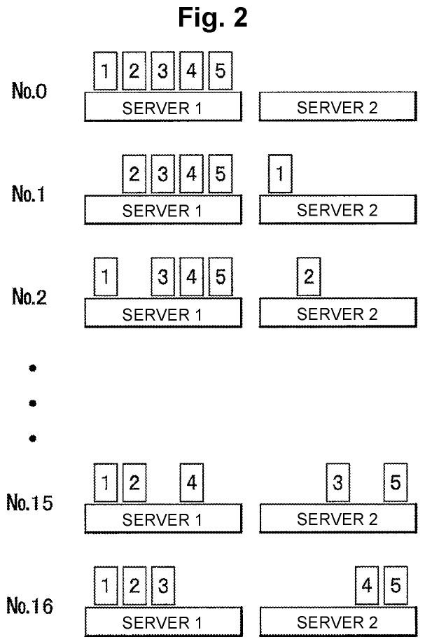

FIG. 2 is a diagram illustrating possible variations when the VMs are arranged on the two servers.

In the following description of the operation, one of the two servers is referred to as a server 1 and the other is referred to as a server 2.

When five VMs are provided on the server 1 and the server 2, if a majority of the VMs have to be arranged on the server 1, 16 app arrangements (No. 1 to No. 16) of the five VMs are possible as shown in FIG. 2. For example, in No. 0, five VMs “1,” “2,” “3,” “4” and “5” are arranged on the server 1 while no VM is arranged on the server 2. In No. 1, four VMs, the VMs “2,” “3,” “4” and “5,” are arranged on the server 1 while the VM “1” is arranged on the server 2. In No. 2, as compared to the arrangement No. 1, the VM “1” and the VM “2” are interchanged, with the result that four VMs, the VMs “1,” “3,” “4” and “5,” are arranged on the server 1 while the VM “2” is arranged on the server 2. In a similar manner, in No. 16, three VMs, the VMs “1,” “2” and “3,” are arranged on the server 1 while two VMs, the VMs “4” and “5,” are arranged on the server 2.

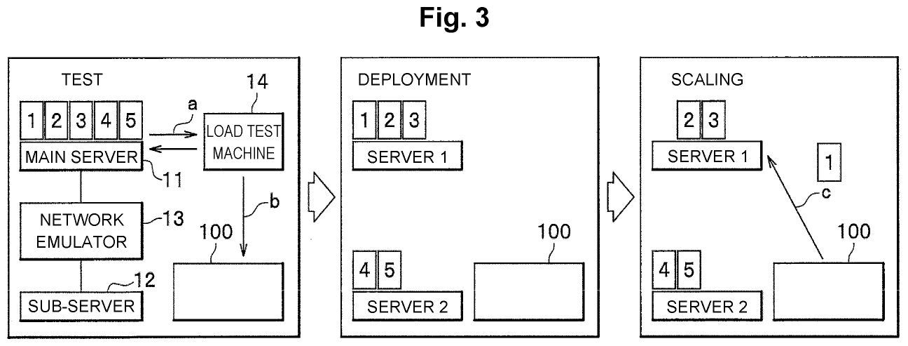

FIG. 3 is a diagram illustrating a test, deployment and scaling by the virtual machine connection control system in a case of arranging VMs on two servers as in FIG. 2.

The left view in FIG. 3 illustrates a test environment that has the same configuration as that shown in FIG. 1. In this test environment, delay and the maximum throughput are measured for all possible variations when VMs included in an app are arranged on two servers.

The middle view in FIG. 3 illustrates a service providing environment. In the service providing environment, the virtual machine connection control device 100 determines “measurement data analysis” (described later) and “deployment” (described later) based on the measurement data analysis. Note that the middle view in FIG. 3 illustrates the arrangement No. 16 in FIG. 2.

The right view in FIG. 3 illustrates an example of scaling performed based on the arrangement obtained as shown in the middle view in FIG. 3. The right view in FIG. 3 illustrates an example in which when a new VM “1” is added, the virtual machine connection control device 100 calculates the optimal arrangement based on data obtained by a test and arranges the VM “1” on the server 1 (see the reference sign c in FIG. 3). Note that the storage unit 140 (see FIG. 1) stores the data obtained by a test.

[Measurement Data Analysis]

The measurement data analysis can be divided into a measurement data analysis for <degrees of coupling between VMs> and a measurement data analysis for <degrees of contention of VMs>.

### <Degrees of Coupling Between VMs>

The degrees of coupling between VMs are described first.

Because different VMs included in an app communicate with each other at different frequencies, arrangements of the VMs in some combinations influence communication delay.

The virtual machine connection control device 100 calculates the degrees of coupling between VMs of a black-box app and uses them as a criterion for arrangement determination.

### Method of Evaluating Degrees of Coupling

A method of evaluating the degrees of coupling will now be described.

<<Step 1>>

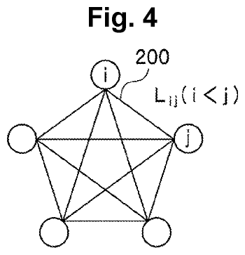

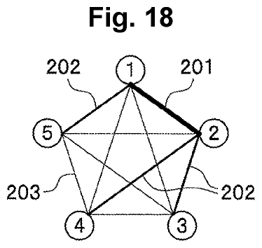

FIG. 4 is a diagram illustrating a configuration of servers in the form of a graph. In FIG. 4, each circle represents a VM and a coupling line 200 between each pair of VMs indicates presence or absence of coupling between the VMs and the degree of the coupling (when coupling is present, the VMs are connected by a solid line). The degree of the coupling is represented by the thickness of the coupling line 200 (solid line). For example, as shown in FIG. 18 described below, the highest degree of coupling is represented by a coupling line 201, a middle degree of coupling is represented by a coupling line 202 and a low degree of coupling is represented by a coupling line 203.

Given that a configuration of servers can be represented by the graph shown in FIG. 4, the degree of coupling between an i-th VM and a j-th VM is defined as Lij (i<j).

<<Step 2>>

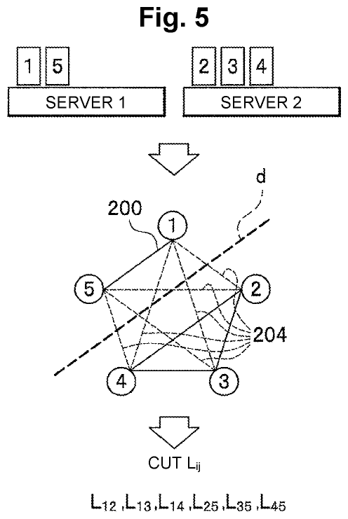

FIG. 5 is a diagram illustrating how a configuration of servers can be divided when the VMs are arranged on two servers: a server 1 and a server 2. The upper view in FIG. 5 illustrates an example of an arrangement of five VMs on two servers and the middle view in FIG. 5 illustrates the configuration of the servers using the arrangement shown in the upper view in the form of a graph. The lower view in FIG. 5 illustrates at which degrees of coupling Lij the configuration of the servers is divided in the middle view in FIG. 5.

In the example shown in the upper view in FIG. 5, two VMs, VMs “1” and “5,” are arranged on the server 1 and three VMs, VMs “2,” “3” and “4,” are arranged on the server 2. Thus, the configuration of the servers can be divided along a dashed line d shown in the middle view in FIG. 5. That is, the configuration of the servers shown in the upper view in FIG. 5 can be divided into one group including “1” and “5” and the other group including combinations of “2” to “4,” i.e., “2” and “3,” “3” and “4” and “2” and “4.” Six coupling lines 204 that intersect the dashed line d in the middle view in FIG. 5 indicate the lowest Lij at which the configuration of the servers can be divided.

As shown in the lower view in FIG. 5, Lijs at which the configuration of the servers can be divided include L₁₂, L₁₃, L₁₄, L₂₅, L₃₅ and L₄₅.

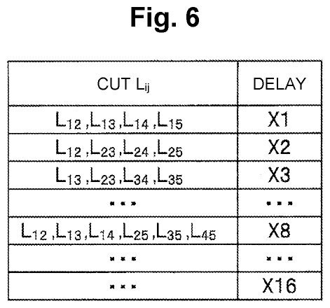

FIG. 6 is a diagram illustrating a correspondence between the degrees of coupling Lij and a measurement result (delay data) obtained in the test stage in the test environment (see the left view in FIG. 3). The storage unit 140 (see FIG. 1) stores the measurement result obtained in the test stage.

As shown in FIG. 6, the storage unit 140 stores Lijs at which the configuration of the servers can be divided in association with delays X1 to X16. In an example shown in FIG. 6, when Lijs at which the configuration of the servers can be divided are L₁₂, L₁₃, L₁₄, L₂₅, L₃₅ and L₄₅, the corresponding “delay” is x8.

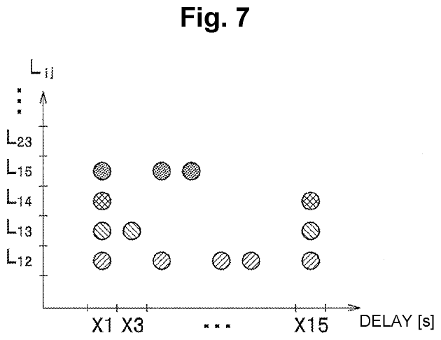

FIG. 7 is a diagram illustrating a correspondence between Lijs at which the configuration of the servers can be divided and the delays [s]. In FIG. 7, points (represented by circles) are plotted where each of the delays X1 to X16 has the corresponding Lij. For example, for L₁₂, points are plotted at delays X1, X4, . . . , X15 and for L₁₃, points are plotted at delays X1, X2 and X15. For L₁₅, points are plotted at delays X1, X4 and X5. The horizontal axis (x axis) in FIG. 7 represents delay [s]. Thus, points plotted on the left side of the horizontal axis indicate better performance in terms of delay. In the above example, L₁₅ is predicted to provide better performance in terms of delay than L₁₂ and L₁₃.

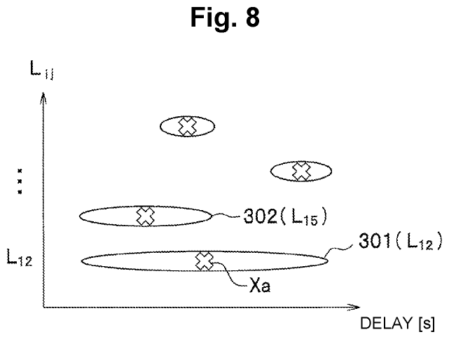

FIG. 8 is a diagram illustrating a method of finding out characteristics of a distribution for each Lij based on the plot of the Lij and delays shown in FIG. 7.

An ellipse in FIG. 8 encloses multiple points plotted for each Lij in FIG. 7. An ellipse 301 in FIG. 8 encloses the points plotted for L₁₂. An ellipse 302 encloses the points plotted for L₁₅.

Characteristics of a distribution for each Lij can be calculated from the average or variance of the plotted points described above. The following describes how to calculate characteristics of a distribution for each Lij using the average. In place of the average, the median, mode, variance and standard deviation may be used for calculating characteristics of a distribution for each Lij.

If the average is used for calculating characteristics of a distribution for each Lij, the “X” marks in the ellipses shown in FIG. 8 represent the average Xa of the distribution for each Lij. Note that the average may be a weighted average in which data points are weighted in a predetermined manner and then summed. It is assumed that for the average Xa for L₁₂ in FIG. 8, L₁₂=Xa.

On the basis of characteristics (the average, variance or standard deviation) of a distribution for each Lij shown in FIG. 8, couplings are determined which cause significant delays when they are cut (i.e., VM “i” and VM “j” are arranged on different servers).

If averages are compared to determine characteristics of a distribution for each Lij, the average of delays in a case where each Lij is cut is used as the “degree of coupling.”

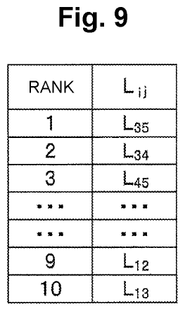

FIG. 9 is a diagram illustrating a table including Lijs in descending order of their average delay.

In an example in FIG. 9, Lijs are arranged in descending order of their average delay in a case where they are cut. L₃₅ has the longest average delay (ranked first in the table) when it is cut, L₁₂ is ranked ninth in the table and L₁₃ is ranked tenth in the table.

When Lijs are arranged in descending order of their average delay in a case where they are cut as shown in FIG. 9, pairs of VMs having highly ranked arcs (tighter coupling) (coupling lines) (see the coupling lines 200 in FIG. 4) are ideally arranged on the same server.

<<Step 3>>

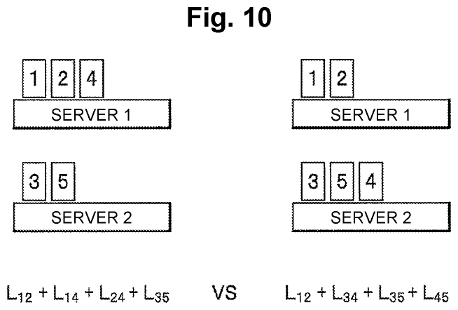

FIG. 10 is a diagram illustrating comparison between different patterns when the VMs are arranged on the server 1 and the server 2. In left view in FIG. 10, three VMs, the VMs “1,” “2” and “4,” are arranged on the server 1 and two VMs, the VMs “3” and “5,” are arranged on the server 2, in which case the sum of Lijs is “L₁₂+L₁₄+L₂₄+L₃₅.” In right view in FIG. 10, two VMs, the VMs “1” and “2,” are arranged on the server 1 and three VMs, the VMs “3,” “5” and “4,” are arranged on the server 2, in which case the sum of Lijs is “L₁₂+L₃₄+L₃₅+L₄₅.”

These two patterns are compared with reference to the table in FIG. 9. A configuration, for which the degree of coupling is larger, causes shorter delay. Delay can be reduced by checking the degrees of coupling and arranging pairs of VMs that have configurations for which the degrees of coupling are larger on the same server.

Although the average of delays in a case where each Lij is cut is used to determine characteristics of a distribution for each Lij in the example described above, the median, mode, or variance may be used in the same manner to determine characteristics of a distribution for each Lij.

<Degrees of Coupling Between VMs> have been described above.

<Degrees of Contention of VMs>

The degrees of contention of VMs are described next.

Contention occurs when VMs are provided on the same server depending on the processing characteristics (for example, high memory occupancy rates) of the VMs.

The virtual machine connection control device 100 calculates the degrees of contention between VMs of a black-box app and uses them as a criterion for arrangement determination.

### Method of Evaluating Degrees of Contention

A method of evaluating the degrees of contention will now be described.

<<Step 1>>

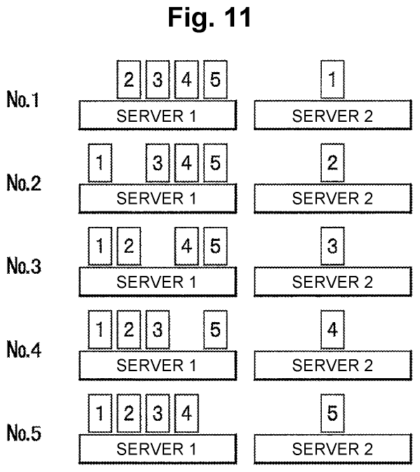

FIG. 11 is a diagram for illustrating the degrees of contention of VMs. The same components have the same reference signs as in FIG. 2. Note that the same notation is used for VMs and servers as in FIG. 2.

As shown in FIG. 11, when five VMs are provided on two servers: a server 1 and a server 2, if four VMs have to be arranged on the server 1 and one VM has to be arranged on the server 2, an app has five possible arrangements (No. 1 to No. 5) of the VMs.

The virtual machine connection control device 100 stores in storage unit 140 (see FIG. 1) the maximum throughput [pps] and the VM arranged on the server 2 when the maximum throughput is achieved using the arrangements No. 1 to No. 5 shown in FIG. 11 based on a measurement result obtained in the test stage (see the left view in FIG. 3).

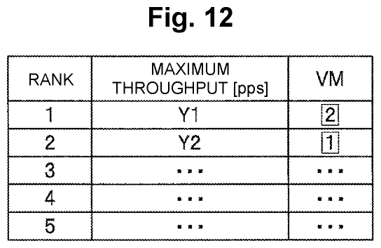

FIG. 12 is a diagram illustrating the maximum throughput [pps] and the VM arranged on the server 2 when the maximum throughput is achieved using the arrangements No. 1 to No. 5 shown in FIG. 11.

As shown in FIG. 12, the arrangement No. 2 shown in FIG. 11 has the maximum throughput Y1, which is ranked first, and the arrangement No. 1 shown in FIG. 11 has the maximum throughput Y2, which is ranked second.

<<Step 2>>

The degree of contention of an i-th VM is defined as Si and the value of Si is set to the maximum throughput when the i-th VM is arranged on the server 2. For example, the degrees of contention Si in the case shown in FIG. 12 are as follows:

S₂=Y1

S₁=Y2

. . .

When Si are arranged in descending order of the maximum throughput, a VM corresponding to higher ranked Si can improve throughput when its resource allocation is increased. That is, such a VM has a major effect on resource contention and therefore, in order to improve throughput, it is desirable to restrict the number of VMs arranged on one server. In addition, contention may be reduced as the sum of the degrees of contention Si of VMs provided on a server is smaller.

<Degrees of Contention of VMs> have been described above. Now that the descriptions of both <Degrees of Coupling between VMs> and <Degrees of Contention of VMs> are complete, the description of [Measurement Data Analysis] concludes here.

[Deployment]

Deployment in the service providing environment (see the middle view in FIG. 3) will be described below.

The following deployment methods may be used.

The virtual machine connection control device 100 (see FIG. 1) determines deployment automatically by way of a scheduler in a controller (e.g., OpenStack).

The scaling control unit 150 of the virtual machine connection control device 100 (see FIG. 1) determines an arrangement based on a measurement result (see the left view in FIG. 3) obtained in the test environment according to prioritized criteria (such as delay and throughput) in the performance requirements of a service.

[Suggestion of Candidate Optimal Arrangement at the Time of Scale Out]

The suggestion of a candidate optimal arrangement at the time of scale out (see the middle view in FIG. 3) will be described below.

The optimal arrangement is determined based on the two indexes, <Degrees of Coupling between VMs> and <Degrees of Contention of VMs>, obtained in [Measurement Data Analysis].

The following describes the arrangement determination in more detail.

<Optimal Arrangement Search Algorithm at the Time of 1 VM Scaling>

The optimal arrangement is determined by comparing the sums of degrees of coupling L of VMs operating on each server and comparing degrees of contention S^{m} of each server m before and after scaling.

### Definitions

The degree of coupling L is defined by the expression (1) below. A larger L indicates a smaller delay.

$$\begin{matrix}[ Math . 1 ] & \\ L = {\sum }_{m} {\sum }_{i < j} {n}_{ij}^{m} {L}_{ij}^{m} & ( 1 )\end{matrix}$$

Lᵢⱼ^{m}: degree of coupling between VMs i and j operating on server m
nᵢⱼ^{m}: the number of Lijs existing on server m

The degree of contention S^{m} is defined by the equation (2) below. A smaller S^{m} results in reduced contention.

$$\begin{matrix}[ Math . 2 ] & \\ {S}^{m} = {\sum }_{i} {n}_{i}^{m} {S}_{i}^{m} & ( 2 )\end{matrix}$$

sᵢ^{m}: degree of contention of VM i operating on server m
nᵢ^{m}: the number of VMs i operating on server m

### Problem Setting

The optimal server is determined when one VM is added to a given arrangement.

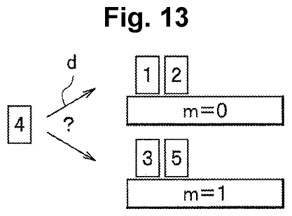

FIG. 13 is a diagram illustrating how to determine the optimal server when a VM “4” is added to an arrangement in which five VMs are provided on two servers.

As shown in FIG. 13, two VMs, VMs “1” and “2,” are arranged on a server m0 and two VMs, VMs “3” and “5,” are arranged on a server m1. In this instance, the VM “4” is added to the server 1 as indicated by the reference sign d in FIG. 13.

A VM is essentially added to a server whose number m is smaller.

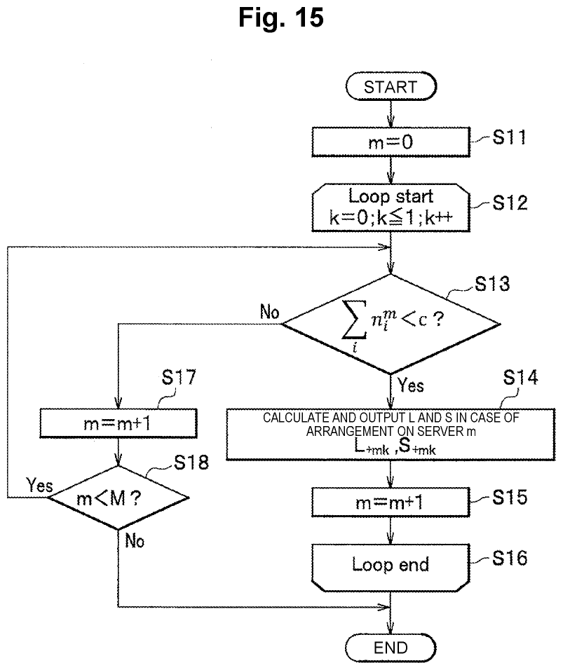

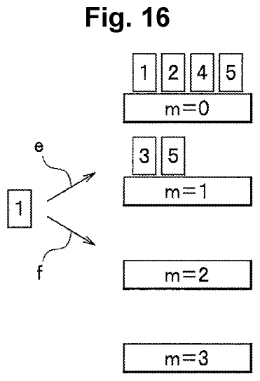

L and S are calculated respectively in a case where the VM is added to the server m0 and in a case where the VM is added to another server whose number is the smallest among servers that have sufficient capacities for the VM. A specific example of calculating L and S when the VM is arranged is described later with reference to a flow chart in FIG. 15 and an illustrative diagram in FIG. 16.

It is assumed that L₊ₘₖ and S₊ₘₖ, which are the result of calculation of L and S^{m} in a case where the VM is added to each server m, have already been obtained.

L₊ₘ₀ and S₊ₘ₀ are L and S^{m} in a case where the VM is added to the server m0.

L₊ₘ₁ and S₊ₘ₁ are L and S^{m} in a case where the VM is added to the server m1.

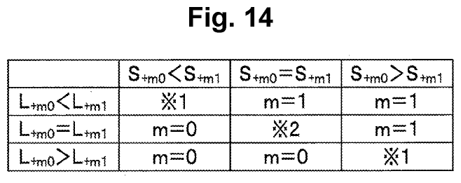

FIG. 14 is a diagram illustrating a method of determining a server to which a VM is added when the VM is added to the arrangement shown in FIG. 13.

The scaling prediction calculation section 151 of the scaling control unit 150 (see FIG. 1) creates a table shown in FIG. 14 by comparing the values of L and S^{m} described above. A server to which the VM is added is determined based on the combinations shown in the table in FIG. 14.

That is, a matrix is created for L₊ₘ₀<L₊ₘ₁, L₊ₘ₀=L₊ₘ₁, L₊ₘ₀≥L₊ₘ₁ and S₊ₘ₀<S₊ₘ₁, S₊ₘ₀=S₊ₘ₁, S₊ₘ₀≥S₊ₘ₁ and it is then determined which pattern in the matrix matches L and S^{m} of the server m0 and the server m1.

A symbol *1 in FIG. 14 indicates a pattern for which a determination is made according to service requirements. For example, (1) for a service in which reduction of delay has great importance, L is prioritized and a server having larger L is selected. In contrast, (2) for a service in which high throughput has great importance, S^{m} is prioritized and a server having smaller S^{m} is selected.

FIG. 15 is a flow chart for calculating L and S in a case where two servers are selected which have sufficient capacities and a VM is arranged on each of the servers. This flow may be written in C language, for example.

In step S11, the scaling prediction calculation section 151 of the scaling control unit 150 (see FIG. 1) sets the current server m to the server m0.

The scaling prediction calculation section 151 repeats a process of steps S13 to S15 between the Loop start in step S12 and the Loop end in step S16 for each VM to be arranged.

In step S12, the loop starts (k=0; k≤1; k++). That is, L and S in a case where the VM is arranged to operate on the first server are calculated by repeating the process between the Loop start and the Loop end in step S16 with k=0, which specifies the first server. After that, L and S in a case where the VM is arranged to operate on the second server are calculated by repeating the process with k=1, which specifies the second server.

In step S13, it is determined whether Σn₁^{m}, the number of VMs i operating on the server m, is smaller than a capacity c, which is the maximum number of VMs that can operate on one server.

If Σn₁^{m}<c (step S13: Yes), in step S14, the degree of coupling analysis unit 120 and the degree of contention analysis unit 130 (see FIG. 1) calculate L and S in a case where the VM is arranged on the server m and output the calculation results L₊ₘₖ and S₊ₘₖ.

In step S15, the current server m is set to the next server by incrementing m (m=m+1) and the process proceeds to step S16. After the process is repeated for all the VMs to be arranged on the server m, this flow ends.

If Σn₁^{m}≥c (step S13: No), in step S17, the current server m is set to the next server by incrementing m (m=m+1) and the process proceeds to step S18.

In step S18, the virtual machine connection control device 100 determines whether m is smaller than the upper limit M of the number of servers or not.

If m<M (step S18: Yes), the process returns to step S13 and L and S^{m} in a case where the VM is arranged on the next server are calculated.

If m≥M (step S18: No), it is determined that the arrangements of all the VMs on the servers have been determined and this flow ends.

FIG. 16 is a diagram illustrating server selection and an arrangement of VMs on servers when the flow in FIG. 15 is used. It is assumed that the capacity c, which is the maximum number of VMs that can operate on one server, is four.

As shown in FIG. 16, four VMs, VMs “1,” “2,” “4” and “5,” are arranged on a server m0 and two VMs, VMs “3” and “5,” are arranged on a server m1. Any other VM cannot be arranged on the server m0 because the capacity c, which is the maximum number of VMs that can operate on one server, is four. Two more servers can operate on the server m1.

A server having a sufficient capacity for a VM is selected in ascending order of the server number m by executing the flow in FIG. 15. In the example shown in FIG. 16, the determination in step S13 in FIG. 15 is performed for the server m0. Because the number of VMs operating on the server m0, i.e., the VMs “1,” “2,” “4” and “5,” is equal to the capacity c, “4,” which is the maximum number of VMs that can operate on this server, the server m0 is not selected as the first server (S13 in FIG. 15: No). In step 17 in FIG. 15, the current server m is set to the server m1 by incrementing m. Then, the determination in step S13 in FIG. 15 is performed for the server m1. Because the number “2” of VMs operating on the server m1, i.e., the VMs “2” and “5,” is smaller than the aforementioned capacity c, “4,” the server m1 is selected as the first server (see the reference sign e in FIG. 16). In the same manner, a server m2 is selected as the first server (see the reference sign f in FIG. 16).

Then, L and S^{m} in a case where a VM “1” is added to and arranged on the server m1 are calculated. Similarly, L and S^{m} in a case where a VM “1” is added to and arranged on the server m2 are calculated.

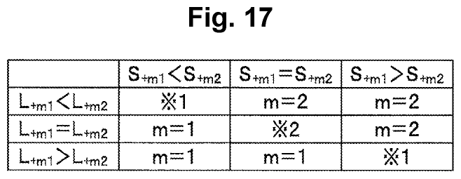

FIG. 17 is a diagram illustrating a method of determining a server to which a VM is added when the VM is added to the arrangement shown in FIG. 16.

It is assumed that L₊ₘₖ and S₊ₘₖ, which are the result of calculation of L and S^{m} in a case where the VM is added to each server m, have already been obtained by executing the flow in FIG. 15.

L₊ₘ₁, and S₊ₘ₁ are L and S^{m} in a case where the VM is added to the server m1.

L₊ₘ₂ and S₊ₘ₂ are L and S^{m} in a case where the VM is added to the server m2.

A table shown in FIG. 17 is created by comparing the values of L and S^{m} described above. A server to which the VM is added is determined based on the combinations shown in the table in FIG. 17.

That is, a matrix is created for L₊ₘ₁<L₊ₘ₂, L₊ₘ₁=L₊ₘ₂, L₊ₘ₁≥L₊ₘ₂ and S₊ₘ₁<S₊ₘ₂, S₊ₘ₁=S₊ₘ₂, S₊ₘ₁≥S₊ₘ₂ and it is then determined which pattern in the matrix matches L and S^{m} of the server m1 and the server m2. A server to which the VM is added is then determined based on the combinations shown in the table in FIG. 17.

A symbol *1 in FIG. 17 indicates a pattern for which a determination is made according to service requirements. For example, (1) for a service in which reduction of delay has great importance, L is prioritized and a server having larger L is selected. In contrast, (2) for a service in which high throughput has great importance, S^{m} is prioritized and a server having smaller S^{m} is selected.

A symbol *2 in FIG. 17 indicates a pattern for which a server is selected which is less affected (in terms of contention and a resource usage rate) when another VM is added afterward.

### Example Using Specific Numerical Values

An example using specific numerical values is described.

An app that has five components is assumed. It is assumed that the five components are VMs “1,” “2,” “3,” “4” and “5.”

FIG. 18 is a diagram illustrating a configuration of servers in the form of a graph. For example, a degree of coupling L₁₂ between the VMs “1” and “2” included in the black-box app is the largest and therefore a coupling line 201 representing the degree of coupling is the thickest. Degrees of coupling L₁₂, L₁₃ and L₂₄ between the VMs “1” and “5,” the VMs “2” and “3” and the VMs “2” and “4” have medium values and coupling lines 202 representing these degrees of coupling have a medium thickness.

It is assumed that the following degrees of coupling and the degrees of contention have already been obtained by analysis.

### Degrees of Coupling

L₁₂₌₅₀, L₁₃=5, L₁₄=7, L₁₅=10, L₂₃=20, L₂₄=15, L₂₅=2, L₃₄=5, L₃₅=5, L₄₅=6

### Degrees of Contention

S₁=50, S₂=50, S₃=100, S₄=50, S₅=10

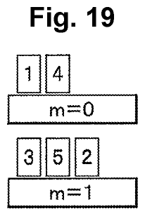

FIG. 19 is a diagram illustrating how to determine the optimal server when a VM “3” is added to the initial deployment configuration in which the five VMs are provided on two servers: a server m0 and a server m1.

Lm0 and Sm0 in a case where a VM “3” is added to the server m0 are as follows:

Lm0=L₁₄+L₁₃+L₃₄+L₃₅+L₂₃+L₂₅=44

Sm0=S₁+S₄+S₃=200

Lm1 and Sm1 in a case where a VM “3” is added to the server m1 are as follows:

Lm1=L₁₄+L₂₃+L₂₅+L₃₅=34

Sm1=S₂+S₅+S₃+S₃=240

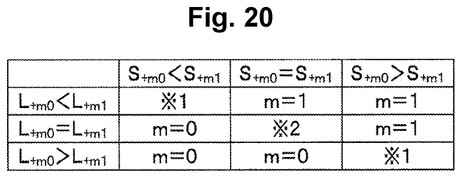

A server to which a VM “3” is added is determined by a server determination method described below (see FIG. 20) using the degrees of coupling Lm0 and Lm1 and the degrees of contention Sm0 and Sm1.

FIG. 20 is a diagram illustrating a method of determining a server to which a VM is added when the VM is added to the arrangement shown in FIG. 19. The same symbols have the same meanings as in FIG. 17.

As shown in FIG. 20, a matrix is created for L₊ₘ₀<L₊ₘ₁, L₊ₘ₀=L₊ₘ₁, L₊ₘ₀≥L₊ₘ₁ and S₊ₘ₀<S₊ₘ₁, S₊ₘ₀=S₊ₘ₁, S₊ₘ₀≥S₊ₘ₁ and it is then determined which pattern in the matrix matches L and Sm of the server m0 and the server m1. A server to which the VM is added is then determined based on the combinations shown in the table in FIG. 17.

As a result, because Lₘ₀>Lₘ₁ and Sₘ₀<Sₘ₁, the arrangement is determined according to service requirements. For example, for a service in which reduction of delay has great importance, m=0 is used. In contrast, for a service in which high throughput has great importance, m=1 is used.

[Hardware Configuration]

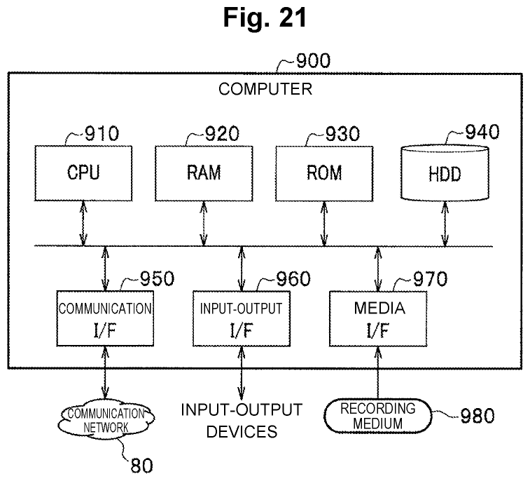

The virtual machine connection control device 100 according to the present embodiment can be implemented, for example, by a computer 900 having a configuration shown in FIG. 21.

FIG. 21 is a hardware block diagram illustrating an example of the computer 900 implementing the virtual machine connection control device 100.

The computer 900 includes a CPU 910, a RAM 920, a ROM 930, an HDD 940, a communication interface (I/F) 950, an input-output interface (I/F) 960 and a media interface (I/F) 970.

The CPU 910 operates to control other components according to programs stored in the ROM 930 or the HDD 940. The ROM 930 stores a boot program executed by the CPU 910 at the time of start-up of the computer 900 and programs depending on hardware of the computer 900.

The HDD 940 stores programs executed by the CPU 910 and data used by those programs. The communication interface 950 receives data from other equipment via a communication network 80 and transmits the data to the CPU 910, and transmits data created by the CPU 910 to other equipment via the communication network 80.

CPU 910 controls output devices such as a display and a printer and input devices such as a keyboard and a mouse via the input-output interface 960. The CPU 910 obtains data from the input devices via the input-output interface 960. The CPU 910 outputs created data to the output devices via input-output interface 960.

The media interface 970 reads a program or data stored in a recording medium 980 and provides the program or data to the CPU 910 via the RAM 920. The CPU 910 loads such a program from the recording medium 980 into the RAM 920 via the media interface 970 and executes the loaded program. The recording medium 980 may be an optical recording medium such as a Digital Versatile Disc (DVD) and a Phasechangerewritable Disk (PD), a magneto-optical recording medium such as a Magneto Optical disk (MO), a tape medium, magnetic recording medium or a semiconductor memory.

For example, when the computer 900 operates as the virtual machine connection control device 100 according to the present embodiment, the CPU 910 of the computer 900 realizes the functions of components of the virtual machine connection control device 100 by executing programs loaded into the RAM 920. The HDD 940 stores data for the components of the virtual machine connection control device 100. The CPU 910 of the computer 900 reads and executes those programs from the recording medium 980 but, for another example, the CPU 910 may obtain those programs from other equipment via the communication network 80.

[Effects]

As described above, the virtual machine connection control device 100 for arranging virtual machines on servers includes the data collection unit 110 configured to obtain VNF performance measured for arrangements of virtual machines included in an application to be tested on at least two servers in all possible combinations, the degree of coupling analysis unit 120 configured to calculate degrees of coupling associated with communication delay between the virtual machines included in the application based on measurement data of the obtained VNF performance, the degree of contention analysis unit 130 configured to calculate degrees of contention associated with degradation of the VNF performance between the virtual machines included in the application based on measurement data of the obtained VNF performance, and the scaling control unit 150 configured to determine an arrangement of the virtual machines that provides the VNF performance higher than a predetermined threshold (e.g., the maximum VNF performance) based on calculated degrees of coupling and calculated degrees of contention.

This can easily be applied to an actual system and make it possible to determine an arrangement of virtual machines which maximizes the VNF performance (delay and throughput) without real-time data collection.

In prior art, VMs for monitoring and analyzing traffic are required on servers. The present invention does not require real-time data collection and thus resources that would otherwise be allocated to a resident monitoring system for real-time data collection can be reduced. Accordingly, resource use efficiency can be improved.

In addition, performance degradation due to bottlenecks (traffic concentration on certain points) can be avoided.

In the virtual machine connection control device 100, the degree of coupling is defined based on how much the VNF performance is degraded by communication delay between a pair of virtual machines or containers. The degree of coupling analysis unit 120 is characterized by setting the degree of coupling to a larger value as the communication delay degrades the VNF performance more.

Thus, by calculating the degrees of coupling between pairs of VMs included in a black-box app and using the calculated degrees of coupling as a criterion for arrangement determination, couplings can be determined which cause significant delays when each corresponding pairs of VMs are arranged on different servers based on characteristics of a distribution for each corresponding cut Lij.

In the virtual machine connection control device 100, the degree of contention is defined based on how much the VNF performance is degraded by contention between a virtual machine or container and other virtual machines or containers arranged on the same server. The degree of contention analysis unit 130 is characterized by setting the degree of contention to a larger value as contention degrades the VNF performance more based on VNF performance values of an arrangement in which only one virtual machine or container is arranged on one of at least two servers.

Thus, by calculating the degrees of contention between VMs included in a black-box app and using the calculated degrees of contention as a criterion for arrangement determination, the number of VMs arranged on one server can be restricted in consideration of contention caused when VMs are provided on the same server. Besides, throughput can be improved by increasing resource allocation to VMs having higher degrees of contention.

In the virtual machine connection control device 100, when a virtual machine or container is added, the scaling control unit 150 is characterized by selecting at least two servers from a group of servers that have capacities for the addition of the virtual machine or container and then selecting one of the at least two servers based on the calculated degrees of coupling and the calculated degrees of contention.

Thus, when a VM is arranged due to scale out, an arrangement of virtual machines which maximizes the VNF performance (delay and throughput) can be determined.

In the virtual machine connection control device 100, the scaling control unit 150 is characterized by determining a server for which the calculated degree of coupling is larger than a first predetermined value and the calculated degree of contention is smaller than a second predetermined value and, if a server for which the degree of coupling is larger than the first predetermined value is different from a server for which the degree of contention is smaller than the second predetermined value, determining which server is less affected in terms of contention and a resource usage rate when the virtual machine is arranged on the server according to predefined service requirements or due to scale out.

Thus, since a server is selected for which the degree of coupling is large and the degrees of contention is small, an arrangement of the virtual machine that maximizes the VNF performance (delay and throughput) can be determined.

If a server for which the degree of coupling is large is different from a server for which the degree of contention is small, for example, for a service in which a certain predefined service requirement, e.g., reduction of delay, has great importance, the degree of coupling is prioritized and the server for which the degree of coupling is large is selected. For a service in which throughput has great importance, the degree of contention is prioritized and the server for which the degree of contention is small is selected. Furthermore, it is possible to prepare for future scale out by arranging the virtual machine on a server that is less affected in terms of contention and a resource usage rate when another VM is added afterward.

The virtual machine connection control system 1000 includes: the virtual machine connection control device 100 configured to arrange virtual machines on servers; and the load test device (load test machine 14) configured to connect to the servers to obtain data on delay and the maximum throughput, where the load test device is further configured to measure VNF performance by arranging virtual machines included in an application to be tested on at least two servers in all possible combinations, and the virtual machine connection control device 100 includes: the data collection unit 110 configured to obtain the VNF performance measured by the load test device; the degree of coupling analysis unit 120 configured to calculate degrees of coupling associated with communication delay between the virtual machines included in the application based on measurement data of the obtained VNF performance; the degree of contention analysis unit 130 configured to calculate degrees of contention associated with degradation of the VNF performance between the virtual machines included in the application based on measurement data of the obtained VNF performance; and the scaling control unit 150 configured to determine an arrangement of the virtual machines that provides the VNF performance higher than a predetermined threshold based on the calculated degrees of coupling and the calculated degrees of contention when the virtual machines are arranged due to scale out.

Accordingly, the load test device measures the VNF performance by arranging virtual machines included in an application to be tested on at least two servers in all possible combinations. The virtual machine connection control device 100 calculates, for the VMs/containers, the degrees of coupling between the VMs/containers and the degrees of contention of the VMs/containers based on measurement data of the VNF performance measured by the load test device. The virtual machine connection control device 100 can then determine a VM/container arrangement that maximizes the VNF performance (delay and throughput) by using an arrangement determination algorithm with the calculated degrees of coupling and the degrees of contention.

Some or all of the processes described as being executed automatically in the above embodiment may be executed manually, and some or all of the processes described as being executed manually in the above embodiment may be executed automatically by a publicly known method. Moreover, unless specifically stated otherwise, the process procedures, control procedures, specific names, and information including various data and parameters described in this specification or the drawings may be changed as desired.

The components of the devices illustrated in the drawings are merely illustrative of conceptual functions and do not need to be physically arranged as shown in the drawings. That is, specific implementation of distribution and integration of the devices is not limited to that shown in the drawings, and some or all of the devices may be separated or integrated functionally or physically in any desired units depending on the load on or usage of them.

Some or all of the above-mentioned configurations, functions, processing units and processing means may be realized using hardware, for example, by designing them as integrated circuits. Alternatively, the above-mentioned configurations and functions may be realized using software for a processor to interpret and execute programs that implements those functions. Programs, tables and information such as files for implementing the functions may be stored in a recording device such as a memory, a hard disk and a Solid State Drive (SSD) or in a recording medium such as an Integrated Circuit (IC) card, a Secure Digital (SD) card and an optical disc.

### REFERENCE SIGNS LIST

11 Main server
12 Sub-server
13 Network emulator
14 Load test machine (load test device)
100 Virtual machine connection control device
110 Data collection unit
120 Degree of coupling analysis unit
130 Degree of contention analysis unit
140 Storage unit
150 Scaling control unit
151 Scaling prediction calculation section
152 Scaling execution section
1000 Virtual machine connection control system

1. A virtual machine connection control device for arranging virtual machines on servers, comprising:
a data collection unit including one or more processors configured to obtain Network Functions Virtualization (VNF) performance measured for arrangements of virtual machines included in an application to be tested on at least two servers in all possible combinations;
a degree of coupling analysis unit including one or more processors, configured to calculate degrees of coupling associated with communication delay between the virtual machines included in the application based on measurement data of the obtained VNF performance;
a degree of contention analysis unit, including one or more processors, configured to calculate degrees of contention associated with degradation of the VNF performance between the virtual machines included in the application based on measurement data of the obtained VNF performance; and
a scaling control unit including one or more processors, configured to determine an arrangement of the virtual machines that provides the VNF performance higher than a predetermined threshold based on the calculated degrees of coupling and the calculated degrees of contention.

2. The virtual machine connection control device according to claim 1, wherein
the degree of coupling is defined based on how much the VNF performance is degraded by communication delay between each pair of the virtual machines or containers, and
the degree of coupling analysis unit is further configured to set the degree of coupling to a larger value as the communication delay degrades the VNF performance more.

3. The virtual machine connection control device according to claim 1, wherein
the degree of contention is defined based on how much the VNF performance is degraded by contention between each of the virtual machines or containers and other virtual machines or containers of the virtual machines or the containers that are arranged on the same server, and
the degree of contention analysis unit is further configured to set the degree of contention to a larger value as the contention degrades the VNF performance more based on VNF performance values of an arrangement in which only one of the virtual machines or the containers is arranged on one of the at least two servers.

4. The virtual machine connection control device according to claim 1, wherein
the scaling control unit is further configured to, when the virtual machines or containers are added, select the at least two servers from a group of servers that have capacities for addition of the virtual machines or the containers and select one of the at least two servers based on the calculated degrees of coupling and the calculated degrees of contention.

5. The virtual machine connection control device according to claim 1, wherein
the scaling control unit is further configured to determine for which of the servers the calculated degree of coupling is larger than a first predetermined value and the calculated degree of contention is smaller than a second predetermined value and, if a server for which the degree of coupling is larger than the first predetermined value is different from a server for which the degree of contention is smaller than the second predetermined value, determine which of the servers is less affected in terms of contention and a resource usage rate when the virtual machines are arranged on the server according to predefined service requirements or due to scale out.

6. A virtual machine connection control system comprising:
a virtual machine connection control device configured to arrange virtual machines on servers; and
a load test device configured to connect to the servers to obtain data on delay and maximum throughput, wherein
the load test device is further configured to measure Network Functions Virtualization (VNF) performance by arranging virtual machines included in an application to be tested on at least two servers in all possible combinations,
the virtual machine connection control device comprises:
a data collection unit including one or more processors, configured to obtain the VNF performance measured by the load test device;
a degree of coupling analysis unit, including one or more processors, configured to calculate degrees of coupling associated with communication delay between the virtual machines included in the application based on measurement data of the obtained VNF performance;
a degree of contention analysis unit, including one or more processors, configured to calculate degrees of contention associated with degradation of the VNF performance between the virtual machines included in the application based on measurement data of the obtained VNF performance; and
a scaling control unit including one or more processors, configured to determine an arrangement of the virtual machines that provides the VNF performance higher than a predetermined threshold based on the calculated degrees of coupling and the calculated degrees of contention when the virtual machines are arranged due to scale out.

7. A virtual machine connection control method implemented by a virtual machine connection control device for arranging virtual machines on servers, comprising:
the virtual machine connection control device
obtaining Network Functions Virtualization (VNF) performance measured for arrangements of virtual machines included in an application to be tested on at least two servers in all possible combinations;
calculating degrees of coupling associated with communication delay between the virtual machines included in the application based on measurement data of the obtained VNF performance;
calculating degrees of contention associated with degradation of the VNF performance between the virtual machines included in the application based on measurement data of the obtained VNF performance; and
determining an arrangement of the virtual machines that provides the VNF performance higher than a predetermined threshold based on the calculated degrees of coupling and the calculated degrees of contention.

8. A program for instructing a computer to function as the virtual machine connection control device according to claim 1.

9. The virtual machine connection control system according to claim 6, wherein
the degree of coupling is defined based on how much the VNF performance is degraded by communication delay between each pair of the virtual machines or containers, and
the degree of coupling analysis unit is further configured to set the degree of coupling to a larger value as the communication delay degrades the VNF performance more.

10. The virtual machine connection control system according to claim 6, wherein
the degree of contention is defined based on how much the VNF performance is degraded by contention between each of the virtual machines or containers and other virtual machines or containers of the virtual machines or the containers that are arranged on the same server, and
the degree of contention analysis unit is further configured to set the degree of contention to a larger value as the contention degrades the VNF performance more based on VNF performance values of an arrangement in which only one of the virtual machines or the containers is arranged on one of the at least two servers.

11. The virtual machine connection control system according to claim 6, wherein
the scaling control unit is further configured to, when the virtual machines or containers are added, select the at least two servers from a group of servers that have capacities for addition of the virtual machines or the containers and select one of the at least two servers based on the calculated degrees of coupling and the calculated degrees of contention.

12. The virtual machine connection control system according to claim 6, wherein
the scaling control unit is further configured to determine for which of the servers the calculated degree of coupling is larger than a first predetermined value and the calculated degree of contention is smaller than a second predetermined value and, if a server for which the degree of coupling is larger than the first predetermined value is different from a server for which the degree of contention is smaller than the second predetermined value, determine which of the servers is less affected in terms of contention and a resource usage rate when the virtual machines are arranged on the server according to predefined service requirements or due to scale out.

13. The virtual machine connection control method according to claim 7, wherein
the degree of coupling is defined based on how much the VNF performance is degraded by communication delay between each pair of the virtual machines or containers, and
wherein the method further comprises:
setting the degree of coupling to a larger value as the communication delay degrades the VNF performance more.

14. The virtual machine connection control method according to claim 7, wherein
the degree of contention is defined based on how much the VNF performance is degraded by contention between each of the virtual machines or containers and other virtual machines or containers of the virtual machines or the containers that are arranged on the same server, and
wherein the method further comprises:
setting the degree of contention to a larger value as the contention degrades the VNF performance more based on VNF performance values of an arrangement in which only one of the virtual machines or the containers is arranged on one of the at least two servers.

15. The virtual machine connection control method according to claim 7, further comprising:
when the virtual machines or containers are added, selecting the at least two servers from a group of servers that have capacities for addition of the virtual machines or the containers and selecting one of the at least two servers based on the calculated degrees of coupling and the calculated degrees of contention.

16. The virtual machine connection control method according to claim 7, further comprising:
determining for which of the servers the calculated degree of coupling is larger than a first predetermined value and the calculated degree of contention is smaller than a second predetermined value and,
if a server for which the degree of coupling is larger than the first predetermined value is different from a server for which the degree of contention is smaller than the second predetermined value, determining which of the servers is less affected in terms of contention and a resource usage rate when the virtual machines are arranged on the server according to predefined service requirements or due to scale out.
